(19) United States
(12) Patent Application Publication
(10) Pub. No.: US 2022/0085890 A1
(43) Pub. Date: Mar. 17, 2022

(54) OPTICAL COMMUNICATION MODULE EQUIPPED WITH VOLTAGE HOLDING MECHANISM

(71) Applicant: Fujitsu Optical Components Limited, Kawasaki-shi (JP)

(72) Inventor: Katsuhiko Hakomori, Kawasaki (JP)

(73) Assignee: Fujitsu Optical Components Limited, Kawasaki-shi (JP)

(21) Appl. No.: 17/355,844

(22) Filed: Jun. 23, 2021

(30) Foreign Application Priority Data
Sep. 14, 2020 (JP) 2020-153463

(51) Int. Cl. H04B 10/40; H02M 3/158; H01F 38/14; G02B 6/42

(52) U.S. Cl. CPC H04B 10/40; G02B 6/4203; H01F 38/14; H02M 3/158

(57) ABSTRACT

An optical communication module includes: a circuit board on which a load including an optical device and a switch circuit provided between a power supply and the load are implemented; a case configured to accommodate the circuit board; and a winding configured to be electrically connected to the switch circuit and the load. The case has a protrusion. The protrusion penetrates the winding. The winding, the case and the protrusion configures an inductor.

This application is based upon and claims the benefit of priority of the prior Japanese Patent Application No. 2020-153463, filed on Sep. 14, 2020, the entire contents of which are incorporated herein by reference.

### FIELD

The embodiments discussed herein are related to an optical communication module equipped with a voltage holding mechanism.

### BACKGROUND

Optical communication modules have been widespread as one key component for implementing large capacity optical communication. An example of an optical communication module is an optical transceiver module that includes an optical transmitter and an optical receiver. The optical transmitter generates an optical signal from transmission data and transmits this optical signal. The optical receiver converts a received optical signal into an electric signal so as to recover data.

An optical communication module includes various electric circuits. Thus, a specified power interruption sequence may be required when power supply to the optical communication module is interrupted. For example, a required sequence may be one in which the voltage of a certain circuit is reduced to zero, and then the voltage of another circuit is reduced. In this case, an optical communication module is preferably equipped with a mechanism for holding the voltage of a circuit for a specified time period immediately after power interruption. A mechanism for holding the voltage of a circuit for a specified time period immediately after power interruption may hereinafter be referred to as a “voltage holding mechanism.”

For example, a voltage holding mechanism may be implemented by a capacitor. Alternatively, a voltage holding mechanism may be implemented by an inductor (or a coil). Configurations for temporarily supplying a current to a circuit by using a coil upon power interruption are described in, for example, U.S. Patent Publication No. 2012/0242309, U.S. Patent Publication No. 2010/0045248, U.S. Patent Publication No. 2010/0039080, Japanese Laid-open Patent Publication No. 2009-254169, and Japanese Laid-open Patent Publication No. 2002-262550.

In recent years, optical communication modules have been strongly required to be downsized in addition to being required to perform high-speed processing. For example, the size of an optical transceiver module compliant with the C form-factor pluggable (CFP) may be 82×144.8×13.6 [mm]. The size of a CFP2 module may be 41.5×107.5×12.4 [mm]. The size of a Quad-small-FP 56 (QSFP56) module may be 18.4×72.2×8.5 [mm]. Furthermore, standards for optical transceiver modules having a smaller size than QSFP56 modules have been studied.

In the meantime, when implementing a voltage holding mechanism by using a capacitor or an inductor in accordance with the prior art, such a capacitor or inductor will need to be large-sized. Thus, it is difficult to downsize an optical communication module equipped with a voltage holding mechanism in the prior art.

### SUMMARY

According to an aspect of the embodiments, an optical communication module includes: a circuit board on which a load including an optical device and a switch circuit provided between a power supply and the load are implemented; a case configured to accommodate the circuit board; and a winding configured to be electrically connected to the switch circuit and the load. The case has a protrusion. The protrusion penetrates the winding. The winding, the case and the protrusion configures an inductor.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B illustrate an example of a voltage holding mechanism implemented using a capacitor;

FIGS. 2A and 2B illustrate an example of a voltage holding mechanism implemented using an inductor;

FIG. 3 illustrates an example of an optical communication module in accordance with embodiments of the present invention;

FIG. 4 illustrates an example of the circuit configuration of an optical transceiver module;

FIG. 5 is an explanatory diagram for changes in an applied voltage on a load upon power interruption;

FIG. 6 illustrates an example of the structure of an optical transceiver module;

FIG. 7 illustrates an example of a cross section structure of an optical transceiver module;

FIG. 8 illustrates an example of the shape and size of an optical transceiver module;

FIG. 9 illustrates a variation of the circuit configuration of an optical transceiver module;

FIG. 10 illustrates a variation of the structure of an optical transceiver module; and

FIG. 11 illustrates a magnetic circuit of an optical transceiver module depicted in FIG. 10.

### DESCRIPTION OF EMBODIMENTS

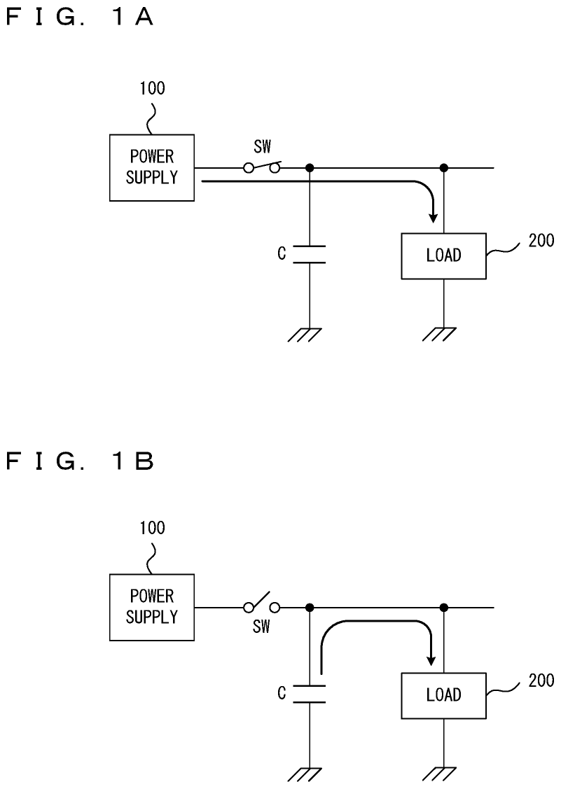

FIGS. 1A and 1B illustrate an example of a voltage holding mechanism implemented using a capacitor. In this example, a load 200 is operated by power supplied from a power supply 100. A switch SW is provided between the power supply 100 and the load 200. The switch SW can interrupt the power supply 100 for the load 200.

The load 200 performs a specified power interruption sequence when the power supply 100 is interrupted. For example, a sequence may be performed in which the voltage of a certain electric circuit in the load 200 is reduced to zero, and then the voltage of another electric circuit in the load 200 is reduced. In this case, a mechanism for holding an applied voltage on the load 200 immediately after interruption of the power supply 100 is necessary. Thus, a voltage holding mechanism is implemented between the switch SW and the load 200. The voltage holding mechanism is implemented by a capacitor C in this example.

When the load 200 is operated, the switch SW is controlled to be ON state, as depicted in FIG. 1A. In this case, power is supplied from the power supply 100 to the load 200, and charge is stored in the capacitor C. Thus, the capacitor C is charged.

The power supply 100 is interrupted when the operation of the load 200 is stopped. Accordingly, when the operation of the load 200 is stopped, the switch SW is controlled to be OFF state, as depicted in FIG. 1B. In this situation, the capacitor C has been charged. Thus, after the switch SW is controlled to be OFF state, the charge stored in the capacitor C will be supplied to the load 200. In particular, a current flows from the capacitor C to the load 200, and the input voltage of the load 200 is held.

However, the capacitor C needs to have a large capacitance in order to hold the input voltage of the load 200 until the load 200 finishes the power interruption sequence. Here, a capacitor with a large capacitance is large-sized. Hence, if a module in which the load 200 is implemented is small-sized, it will be difficult to provide, within the module, the voltage holding mechanism for the configuration depicted in FIGS. 1A and 1B. Moreover, in the configuration depicted in FIGS. 1A and 1B, a rush current for charging the capacitor C is generated when the power supply 100 is turned ON. Especially when the capacitance of the capacitor C is large, a large rush current may be generated, thereby causing a component in the module to fail.

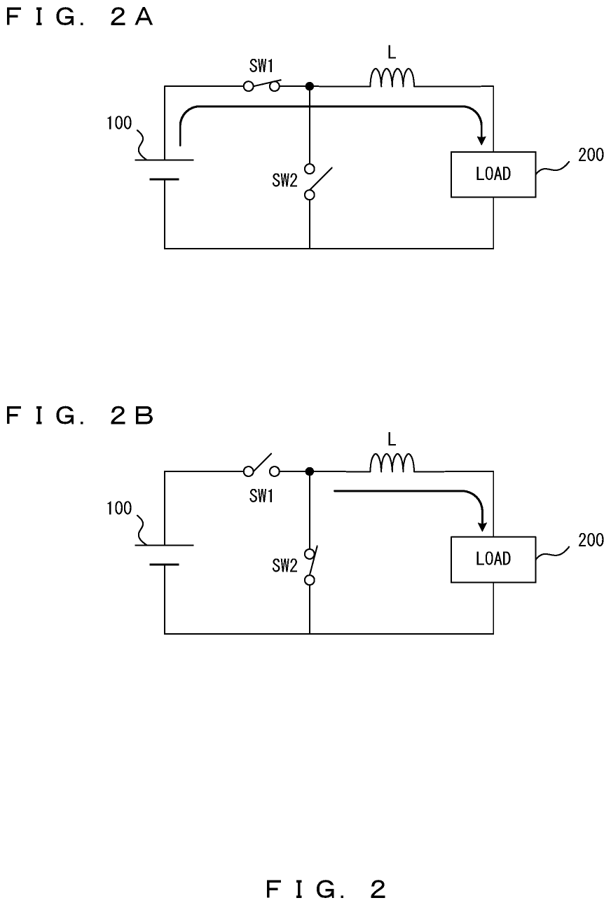

FIGS. 2A and 2B illustrate an example of a voltage holding mechanism implemented using an inductor. As in the example depicted in FIGS. 1A and 1B, a load 200 is operated by power supplied from a power supply 100. A switch SW1 is provided between a positive electrode of the power supply 100 and the load 200.

The voltage holding mechanism includes an inductor L and a switch SW2. The inductor L is provided between the switch SW1 and the load 200. One terminal of the switch SW2 is connected to the switch SW1 and the inductor L. Another terminal of the switch SW2 is connected to a negative electrode of the power supply 100.

When the load 200 is operated, the switch SW1 is controlled to be ON state, and the switch SW2 is controlled to be OFF state, as depicted in FIG. 2A. Thus, a current flows via the switch SW1 and the inductor L. In this case, energy is stored in the inductor L.

The power supply 100 is interrupted when the operation of the load 200 is stopped. Accordingly, when the operation of the load 200 is stopped, the switch SW1 is controlled to be OFF state, as depicted in FIG. 2B. In this case, the switch SW2 is controlled to be ON state. Thus, the energy stored in the inductor L is discharged, thereby supplying a current to the load 200. As a result, the input voltage of the load 200 is held.

In this configuration, a rush current is not generated when the power supply 100 is turned ON, unlike the configuration depicted in FIGS. 1A and 1B. However, even in this configuration, the inductor L needs to have a large inductance in order to hold the input voltage of the load 200 until the load 200 finishes the power interruption sequence. Here, an inductor with a large inductance is large-sized. Hence, if a module in which the load 200 is implemented is small-sized, it will also be difficult to provide, within the module, the voltage holding mechanism for the configuration depicted in FIGS. 2A and 2B.

### Embodiments

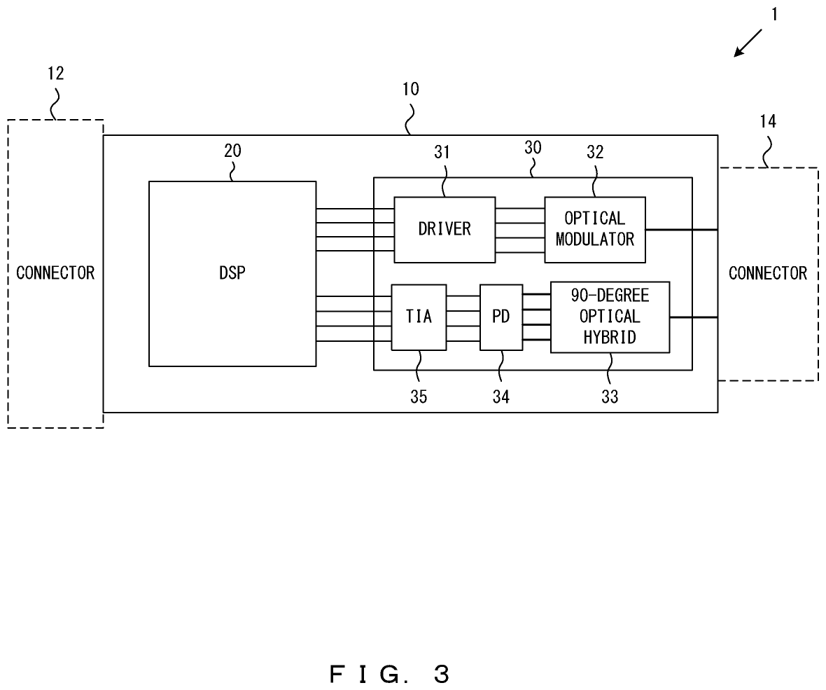

FIG. 3 illustrates an example of an optical communication module in accordance with embodiments of the present invention. In this example, the optical communication module is an optical transceiver module. As depicted in FIG. 3, an optical transceiver module 1 includes a circuit board 10, a connector 12, and a connector 14. The optical transceiver module 1 may include other elements that are not depicted in FIG. 3. For example, the optical transceiver module 1 may include a laser light source. Note that an indication of a case for the optical transceiver module 1 is omitted in FIG. 3.

A DSP 20 and an optical integrated device 30 are implemented on the circuitry board 10. The DSP 20 can generate a transmission signal from data generated by a computer (not illustrated). The DSP 20 can recover data from an electric-field-information signal indicating a received optical signal. In addition, the DSP 20 can control the optical integrated device 30.

The optical integrated device 30 includes an optical transmitter and an optical receiver. The optical transmitter includes a driver 31 and an optical modulator 32. The driver 31 drives the optical modulator 32 by using a transmission signal generated by the DSP 20. The optical modulator 32 generates a modulated optical signal by modulating continuous wave light generated by a light source (not illustrated) with a transmission signal. The modulated optical signal is output via the connector 14.

The optical receiver includes a 90-degree optical hybrid circuit 33, a photodetector circuit 34, and an amplifier circuit (TIA) 35. The 90-degree optical hybrid circuit 33 separates an optical signal received via the connector 14 into an I-phase optical component and a Q-phase optical component orthogonal to each other. The photodetector circuit 34 converts each optical component into an electric signal. The amplifier circuit 35 amplifies an output signal of the photodetector circuit 34. The amplifier circuit 35 converts a current signal output from the photodetector circuit 34 into a voltage signal. An output signal of the amplifier circuit 35 is supplied to the DSP 20.

The connector 12 includes input terminals and output terminals to be connected to a computer (not illustrated). The connector 12 also includes a power-supply terminal to be connected to a DC power supply (not illustrated). The connector 14 includes an optical output port and an optical input port.

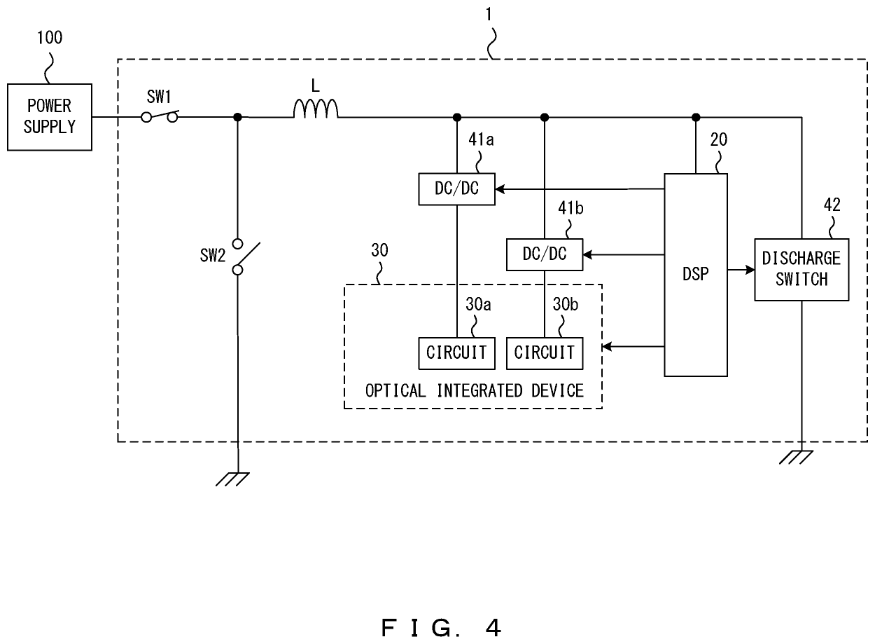

FIG. 4 illustrates an example of the circuit configuration of an optical transceiver module 1. In this example, the optical transceiver module 1 includes switches SW1 and SW2, an inductor L, a DSP 20, an optical integrated device 30, DC/DC converters 41a and 41b, and a discharge switch 42. The optical transceiver module 1 may include other elements that are not depicted in FIG. 4.

Note that the switch SW1, the switch SW2, and the inductor L in FIG. 4 are substantially the same as those in FIG. 2A. Thus, when the switch SW1 is controlled to be ON state and the switch SW2 is controlled to be OFF state, power is supplied from the power supply 100 to the DSP 20 and the optical integrated device 30. The power supply 100 is interrupted when the operation of the optical transceiver module 1 is stopped. In this case, the switch SW1 is controlled to be OFF state, and the switch SW2 is controlled to be ON state. In response to this, as described above by referring to FIG. 2B, the energy stored in the inductor L is discharged, and power continues to be supplied to the DSP 20 and the optical integrated device 30 for a specified time period. Thus, an applied voltage on the DSP 20 and the optical integrated device 30 is held for the specified time period. In this way, the inductor L functions as a voltage holding mechanism.

As described above by referring to FIG. 3, the DSP 20 performs the process of generating a transmission signal and the process of recovering data. In addition, the DSP 20 performs a power interruption sequence. In this example, the DC/DC converters 41a and 41b and the discharge switch 42 are controlled in the power interruption sequence.

As depicted in FIG. 3, the optical integrated device 30 includes the driver 31, the optical modulator 32, the 90-degree optical hybrid circuit 33, the photodetector circuit 34, and the amplifier circuit (TIA) 35. Circuits 30a and 30b depicted in FIG. 4 indicate electric circuits implemented in the optical integrated device 30. The circuit 30a indicates a circuit element for which an applied voltage is to be set to zero early in the power interruption sequence. For example, the circuit 30a may correspond to, but is not particularly limited to, the driver 31 and the photodetector circuit 34. The circuit 30b indicates a circuit element for which an applied voltage is to be set to zero after the applied voltage on the circuit 30a is set to zero in the power interruption sequence. For example, the circuit 30b may correspond to the amplifier circuit 35.

The DC/DC converter 41a generates a DC voltage to be applied to the circuit 30a. The DC/DC converter 41b generates a DC voltage to be applied to the circuit 30b. An output voltage of the DC/DC converter 41a may be different from an output voltage of the DC/DC converter 41b. The discharge switch 42 is provided between a ground and a power-supply line that supplies power to the DSP 20 and the optical integrated device 30. Upon the discharge switch 42 being controlled to be ON state, the voltage of the power-supply line is immediately reduced to zero.

In the optical transceiver module 1, the power interruption sequence starts when the switch SW1 is controlled from ON state to OFF state and the switch SW2 is controlled from OFF state to ON state. Energy has been stored in the inductor L when the power interruption sequence starts. The power interruption sequence is performed by the DSP 20.

In step S1 in the power interruption sequence, the DSP 20 stops output of the DC/DC converter 41a. Thus, the voltage applied to the circuit 30a becomes zero. Then, in step S2, the DSP 20 stops output of the DC/DC converter 41b. Thus, the voltage applied to the circuit 30b becomes zero. Subsequently, in step S3, the DSP 20 controls the discharge switch 42 to be ON state. Accordingly, all the energy that was stored in the inductor L is discharged, and the voltage applied to the DSP 20 becomes zero. In the meantime, some components may fail if applied voltages on all of the electric circuits on the optical integrated device 30 are concurrently interrupted. Thus, in the optical transceiver module 1, the power interruption sequence is performed to protect the components.

The power interruption sequence may be performed by a microcomputer separate from the DSP 20. In this case, firmware for the power interruption sequence may be implemented in the microcomputer.

In the optical transceiver module 1, an applied voltage on loads (in this example, the DSP 20 and the optical integrated device 30) needs to be held at or higher than a specified minimum operation level in order to perform, as described above, the power interruption sequence upon interruption of the power supply 100. In particular, the power interruption sequence cannot be performed if the applied voltage on the DSP 20 is reduced to the specified level or lower. Accordingly, the voltage holding mechanism delays the reduction in an applied voltage on the load upon interruption of the power supply 100. In this case, the length of time from the point at which the power supply 100 is interrupted to the point at which the applied voltage on the load decreases to the minimum operation level needs to be greater than the length of time required to perform the power interruption sequence. For example, when the length of time from the point at which the power supply 100 is interrupted to the point at which step S2 of the power interruption sequence is finished is 0.3 milliseconds, the voltage holding mechanism of the optical transceiver module 1 may be designed such that the length of time from the point at which the power supply 100 is interrupted to the point at which an applied voltage on the load decreases to the minimum operation level or lower is greater than or equal to 0.3 milliseconds. In this example, the minimum operation level corresponds to a voltage required for the DSP 20 to perform operations (e.g., 2.4 V).

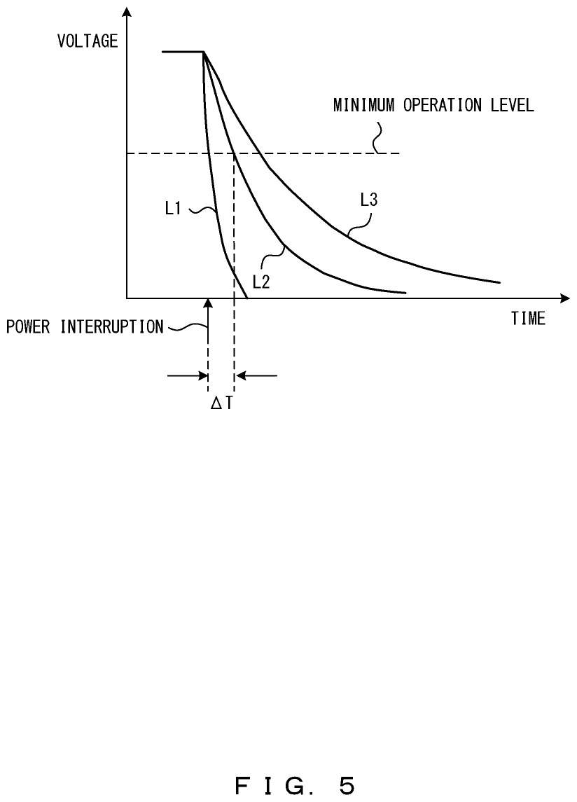

FIG. 5 is an explanatory diagram for changes in an applied voltage on a load upon power interruption. In the graph, the horizontal axis indicates time, and the vertical axis indicates an applied voltage on the load. L1-L3 indicate inductances for an inductor L. L2 is higher than L1, and L3 is higher than L2 (L1<L2<L3).

When the inductance of the inductor L is small, the applied voltage on the load rapidly decreases after the power supply 100 is interrupted. When the inductance of the inductor L is large, the applied voltage on the load slowly decreases. Thus, the larger the inductance of the inductor L, the longer a delay time from a point at which the power supply 100 is interrupted to a point at which the applied voltage on the load decreases to the minimum operation level.

The voltage holding mechanism of the optical transceiver module 1 is designed according to an execution time for the power interruption sequence and the characteristics indicted in FIG. 5. For example, when an execution time (i.e., delay time) ΔT for the power interruption sequence is necessary, the inductance of the inductor L is designed to have a value greater than or equal to L2 indicated in FIG. 5.

When a load is known, a speed of change in the applied voltage on the load after the power interruption can be calculated by using the inductance of the inductor L. In, for example, a simulation performed by the applicant, delay times are respectively 0.3 milliseconds, 1 millisecond, and 2 milliseconds when the inductor L has inductances of 1.5 mH, 5 mH, and 10 mH. In this simulation, the resistance and capacitance of the load were respectively 2.37Ω and 0.1 μF.

According to the simulation, the inductor L needs to have an inductance of 1.5 mH in order to attain a delay time of 0.3 milliseconds. However, implementing such a large inductance by using a typical coil will lead to a large coil size. As an example, a coil having a diameter of 12 mm is commercially available as an inductor having an inductance of 1.5 mH.

Under such a situation, as described above, optical transceiver modules have been strongly required to be downsized in recent years. Thus, inductors to be used as voltage holding mechanisms have also been required to be downsized.

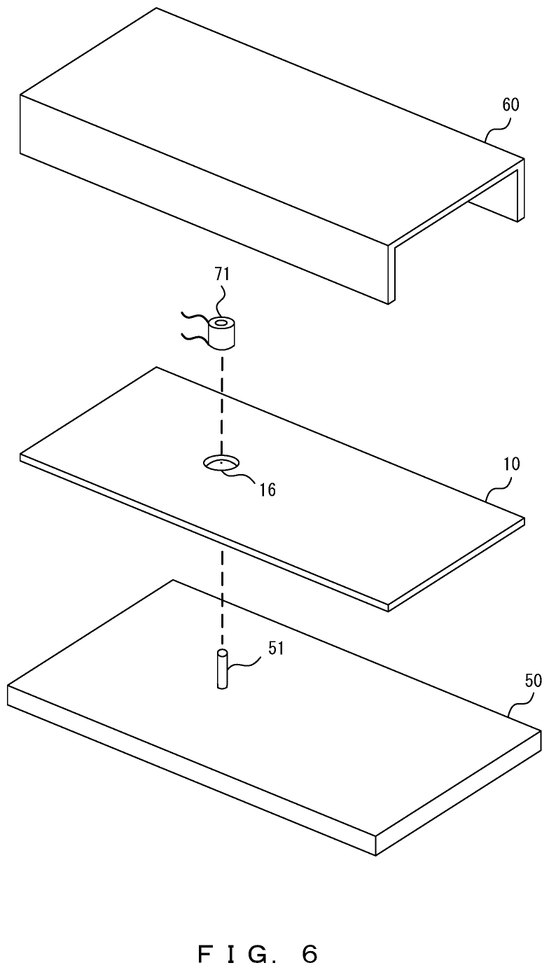

FIG. 6 illustrates an example of the structure of an optical transceiver module 1. In this example, the optical transceiver module 1 includes a circuit board 10, a bottom-side case 50, and a case cover 60, as depicted in FIG. 6. The DSP 20 and the optical integrated device 30 depicted in FIG. 3 are mounted on the upper surface of the circuit board 10. The connectors 12 and 14 depicted in FIG. 3 are attached to edge portions of the circuit board 10.

A winding accommodation hole 16 having a circular shape is formed in the circuit board 10. The winding accommodation hole 16 accommodates a winding 71. Thus, the winding accommodation hole 16 is formed to have a diameter that is slightly larger than that of the winding 71. The winding 71 is provided between the power supply and the load. In the circuit configuration depicted in FIG. 4, one end portion of the winding 71 is electrically connected to the switch SW1, and another end portion of the winding 71 is electrically connected to the DSP 20, the DC/DC converters 41a and 41b, or the like.

The bottom-side case 50 includes a protrusion 51. The protrusion 51 penetrates the winding 71 when the optical transceiver module 1 is assembled. The leading end portion of the protrusion 51 contacts with the case cover 60 when the optical transceiver module 1 is assembled. The bottom-side case 50, the protrusion 51, and the case cover 60 are formed from a magnetic material. For example, the magnetic material may be iron or an iron-based material.

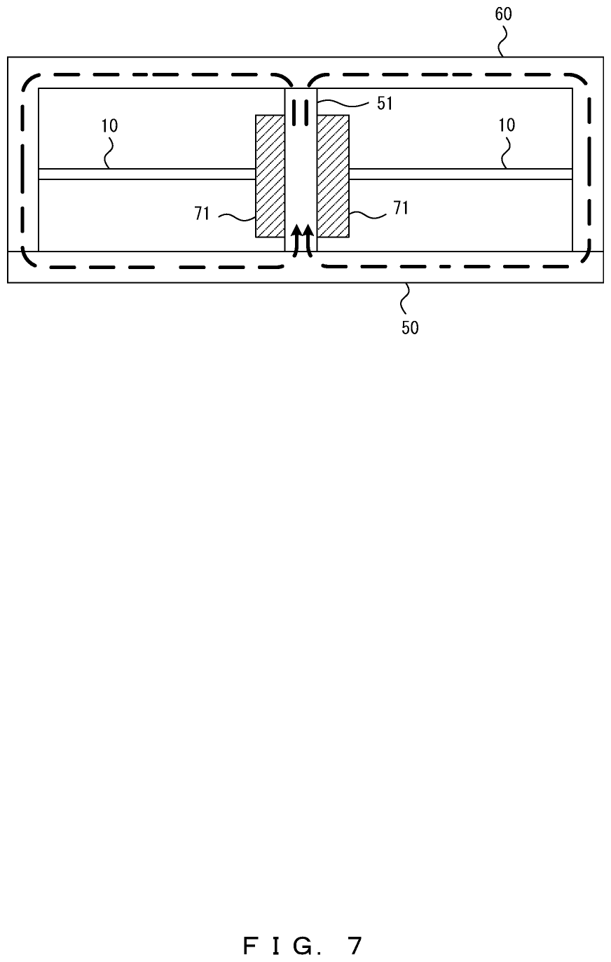

FIG. 7 illustrates an example of a cross section structure of the optical transceiver module 1. In this example, the bottom-side case 50 and the protrusion 51 may be integrally molded. The protrusion 51 penetrates the winding 71. In addition, the leading end portion of the protrusion 51 is in contact with the case cover 60. Accordingly, the bottom-side case 50, the protrusion 51, and the case cover 60 form a magnetic circuit through which magnetic fluxes generated by a current flowing through the winding 71 pass. In particular, the magnetic fluxes indicated by dashed lines are generated when a current flows through the winding 71. The magnetic fluxes leak only slightly, since the bottom-side case 50, the protrusion 51, and the case cover 60 are formed from a magnetic material. As a result, an inductor L having a large inductance will be implemented. Magnetism caused by the inductor L will have substantially no influence on the components of the optical integrated device 30.

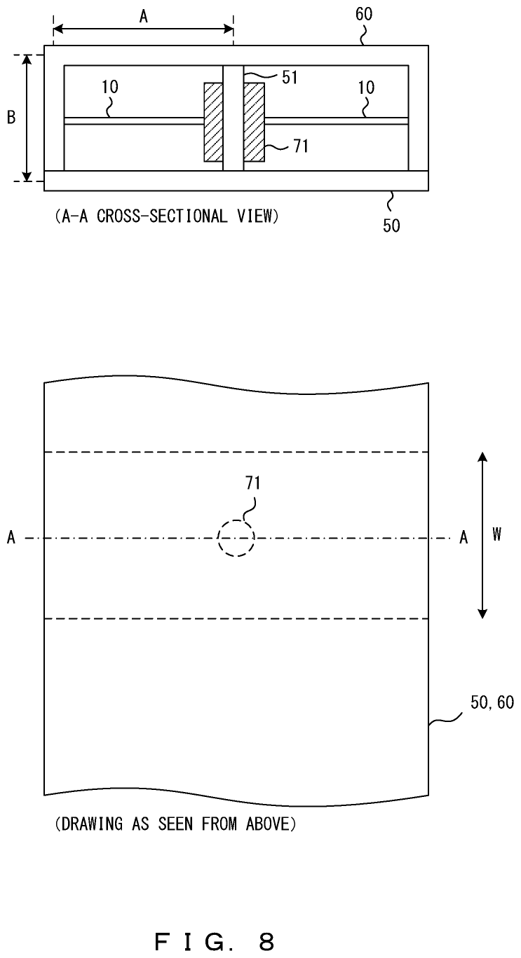

FIG. 8 illustrates an example of the shape and size of the optical transceiver module 1. The following describes conditions to be satisfied to implement an inductor having an inductance of 1.5 mH. Note that FIG. 8 indicates a cross-sectional view of the optical transceiver module 1 and a diagram of the optical transceiver module 1 as seen from above.

### Length A: 8 mm

### Height B: 5 mm

Width W: 6 mm or greater
Relative permeability of bottom-side case 50, protrusion 51, and case cover 60: 6520
Permeability μ of vacuum: 1.25×10⁻⁶ H/m
Cross-sectional area S of protrusion 51: 1.2 mm²
Radius of winding 71: 2 mm
Number N of turns of winding 71: 20

The inductance of the inductor L can be obtained using the following formula.

L=μs×μ×S×N/R

R indicates the path length of the magnetic circuit and corresponds to “A+B+A+B” in the example depicted in FIG. 8. In the example depicted in FIGS. 6-7, the entirety of the bottom-side case 50 and the case cover 60 is formed from a magnetic material, so the width W corresponds to the lengths of the bottom-side case 50 and the case cover 60. For example, a QSFP56 module may have a length of 72.2 mm and thus satisfy the above-described condition (i.e., 6 mm or greater).

In this example, the winding 71 has a radius of 2 mm in order to implement an inductor having an inductance of 1.5 mH. Thus, the diameter of the winding 71 is 4 mm. By contrast, the diameter of a coil is, as described above, 12 mm in a configuration in which an inductor is implemented without using the case of the optical transceiver module 1. Hence, in embodiments of the present invention, only a small area is needed to implement the inductor L. Furthermore, even when the case of the optical transceiver module 1 is used to implement the inductor L, the size of the optical transceiver module 1 is not changed. Accordingly, embodiments of the present invention allow for downsizing of the optical communication module equipped with the mechanism for delaying a reduction in an applied voltage on a load upon interruption of a power supply.

Variation

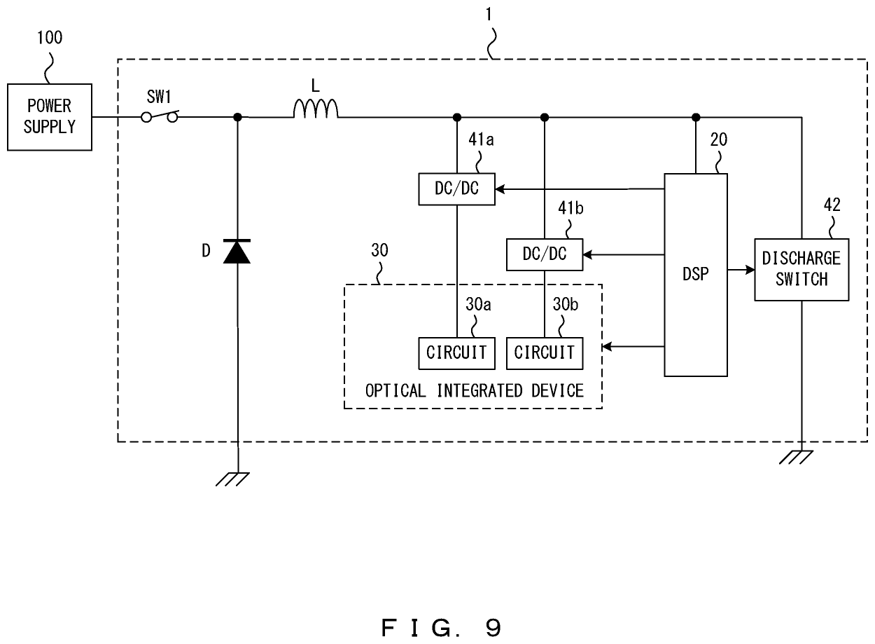

FIG. 9 illustrates a variation of the circuit configuration of the optical transceiver module 1. In the circuit configuration depicted in FIG. 9, a diode D is provided instead of the switch SW2 illustrated in FIG. 4. In this case, a cathode of the diode D is connected to the switch SW1 and the inductor L, and an anode of the diode D is connected to a ground (or the negative electrode of the power supply 100).

When the switch SW1 is controlled to be ON state, the potential of the cathode is higher than that of the anode, so a current does not flow via the diode D. When the switch SW1 is controlled from ON state to OFF state while energy is stored in the inductor L, the potential of the cathode temporarily becomes lower than that of the anode, so a current flows via the diode D. In this way, the diode D implements the same function as the switch SW2 depicted in FIG. 4. Thus, the optical transceiver module 1 depicted in FIG. 9 performs substantially the same operations as the optical transceiver module 1 illustrated in FIG. 4.

For example, the switch SW2 may be implemented by a transistor. In this case, in the configuration depicted in FIG. 4, the state of the switch SW2 needs to be controlled upon interruption of the power supply. However, as a general rule, the ON resistance of a transistor is lower than the ON resistance of a diode. Hence, the configuration illustrated in FIG. 4 will have reduced power consumption in comparison with the configuration depicted in FIG. 9.

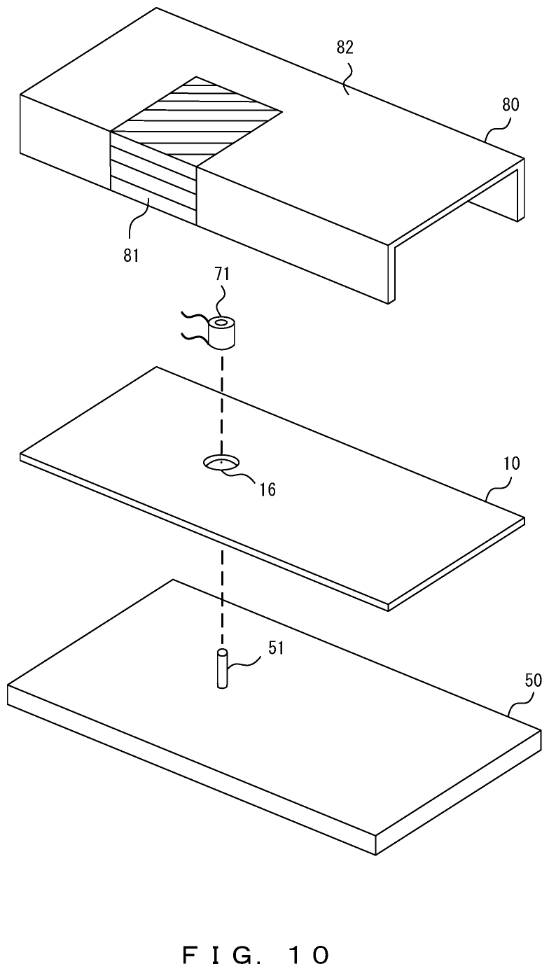

FIG. 10 illustrates a variation of the structure of the optical transceiver module 1. In the structure depicted in FIG. 10, a case cover 80 is used instead of the case cover 60 illustrated in FIG. 6. The shape of the case cover 80 is substantially the same as that of the case cover 60. However, the case cover 80 includes a magnetic material section 81 formed from a magnetic material and a nonmagnetic material section 82 formed from a nonmagnetic material. The magnetic material section 81 is formed to extend from an upper portion of the winding 71 to an edge portion of the case cover 80. Furthermore, the magnetic material section 81 is formed to extend on a side surface of the case cover 80. That is, the magnetic material section 81 contacts with the bottom-side case 50 when the optical transceiver module is assembled. For example, although not particularly limited, the nonmagnetic material section 82 may be formed from plastic. In this example, the bottom-side case 50 and the protrusion 51 are formed from a magnetic material.

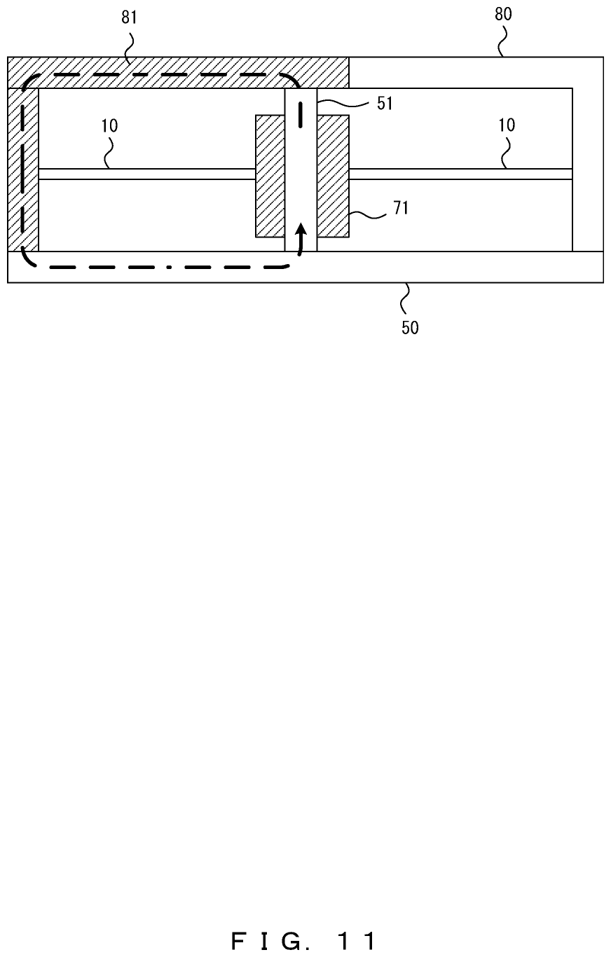

FIG. 11 illustrates a magnetic circuit of the optical transceiver module 1 depicted in FIG. 10. In the optical transceiver module 1 depicted in FIG. 10, the bottom-side case 50, the protrusion 51, and the magnetic material section 81 of the case cover 80 form a magnetic circuit through which a magnetic flux generated by a current flowing through the winding 71 passes. Here, as depicted in FIG. 11, the magnetic material section 81 is in contact with the bottom-side case 50 and the protrusion 51. The structure depicted in FIGS. 10-11 can attain weight reduction of the optical transceiver module 1.

In the examples described above, the winding 71 is accommodated in the winding accommodation hole 16. However, the present invention is not limited to this structure. In particular, the winding 71 may not be accommodated in the winding accommodation hole 16. In this case, the circuit board 10 does not need to include the winding accommodation hole 16.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An optical communication module comprising:
a circuit board on which a load including an optical device and a switch circuit provided between a power supply and the load are implemented;
a case configured to accommodate the circuit board; and
a winding configured to be electrically connected to the switch circuit and the load, wherein
the case has a protrusion,
the protrusion penetrates the winding, and
the winding, the case and the protrusion configures an inductor.

2. The optical communication module according to claim 1, wherein
a winding accommodation hole is formed in the circuit board, and
the winding is accommodated in the winding accommodation hole.

3. The optical communication module according to claim 1, wherein
the case and the protrusion form a magnetic circuit through which a magnetic flux generated by a current flowing through the winding passes.

4. The optical communication module according to claim 3, wherein
the case and the protrusion are formed from a magnetic material.

5. The optical communication module according to claim 3, wherein
the case includes a magnetic material section formed from a magnetic material and a nonmagnetic material section formed from a nonmagnetic material, and
the magnetic material section of the case and the protrusion form a magnetic circuit through which a magnetic flux generated by a current flowing through the winding passes.

6. The optical communication module according to claim 1, wherein
the case includes a bottom-side case and a case cover,
the bottom-side case and the protrusion are integrally molded,
an end portion of the protrusion is in contact with the case cover, and
the bottom-side case, the case cover, and the protrusion form a magnetic circuit through which a magnetic flux generated by a current flowing through the winding passes.

7. The optical communication modulator according to claim 1, wherein
the switch circuit
stores, while the load is in operation, energy in the inductor by causing a current to flow via the winding by using the power supply, and
delays, upon interruption of the power supply, a reduction in an applied voltage on the load by using the energy stored in the inductor.
